(19) United States
(12) Patent Application Publication
(10) Pub. No.: US 2001/0050881 A1
(43) Pub. Date: Dec. 13, 2001

(54) CONTINUOUS FLOW, ELECTROHYDRODYNAMIC MICROMIXING APPARATUS AND METHODS

(76) Inventors: DAVID W. DEPAOLI, KNOXVILLE, TN (US); CONSTANTINOS TSOURIS, OAK RIDGE, TN (US)

Correspondence Address: JOHN S. PRATT, KILPATRICK STOCKTON LLP, 1100 PEACHTREE, SUITE 2800, ATLANTA, GA, 30309, US

(21) Appl. No.: 09/398,675

(22) Filed: Sep. 20, 1999

(51) Int. Cl. B01F 3/08

(52) U.S. Cl. 366/167.1; 366/348; 239/3; 204/554; 204/671

(57) ABSTRACT

The present invention relates to methods and apparatus that employ electrohydrodynamic flows in miscible, partially miscible and immiscible multiphase systems to induce mixing for dissolution and/or reaction processes. The apparatus and methods of the present invention allow micromixing of two or more components and can advantageously be used to conduct liquid-phase reactions uniformly and at high rates

### STATEMENT OF GOVERNMENT LICENSE RIGHTS

This invention was made with Government support under Contract No. DE-AC05-960R22464 awarded by the U.S. Department of Energy to Lockheed Martin Energy Research Corp., and the Government has certain rights in this invention.

### FIELD OF THE INVENTION

The present invention relates to methods and apparatus that employ electrohydrodynamic flows in miscible, partially miscible and immiscible multiphase systems to induce mixing for dissolution and/or reaction processes. The apparatus and methods of the present invention allow micromixing of two or more components and can advantageously be used to conduct liquid-phase reactions uniformly and at high rates.

### BACKGROUND OF THE INVENTION

Micromixing of fluids is important in many manufacturing processes, materials synthesis processes, and separation processes. For example, micromixing plays a significant role in the quality of ultrafine particles formed in liquids by various chemical reactions. Ultrafine particles constitute the key building blocks for diverse advanced structural and functional materials, such as high-performance ceramics and alloys. These advanced materials have tremendous impact in many areas, including catalysts, separations, electronics, energy production processes, and environmental applications. Of particular importance, nanophase ceramic or metallic materials that contain nanosized, less than about 100 nanometer, particles/grains show dramatically improved performance (mechanical, electrical, optical, magnetic, and/or catalytic). The characteristics of ultrafine particles, i.e., size, morphology, monodispersity, purity, and homogeneity of composition directly determine the properties of the materials that are made from them. Thus, the future application of advanced materials depends on the capability to produce particles with outstanding characteristics.

Currently, there is a strong need for more efficient methods of production of high-quality inorganic particles. Ideally, an instantly reactive, continuous process that generates homogeneous ultrafine particles with controllable characteristics is desired. The primary technologies for synthesis of ultrafine particles are liquid-phase chemical and sol-gel processing, and gas-phase condensation. Most of the production processes for both approaches are conducted in batch mode. Gas-phase reactions typically require extreme conditions such as high vacuum and high temperature and give very slow particle production rate. A few continuous, liquid-phase processes have been developed for production of microspheres from alkoxide; however, these involve relatively slow kinetics during hydrolysis and condensation, typically 14 minutes or more reaction time. In contrast, real metal alkoxides are so reactive that agglomerated solids, rather than dispersed particles, are formed under conditions with rapid reaction kinetics. Thus, controlled hydrolysis/condensation of alkoxides in a batch reactor is the usual approach for the production of monodispersed metal oxide precursor powders.

Tubular-type reactors have been designed for the continuous synthesis of ultrafine ceramic particles such as titania and ferric oxide via hydrolysis and condensation of metal alkoxides. In addition, liquid spraying techniques including electrostatic spraying/atomization and ultrasonic spraying of liquids into gas have been used in ceramic particle production.

### SUMMARY OF INVENTION

The present invention provides novel methods and apparatus that employ electrohydrodynamic flows in miscible, partially miscible and immiscible multiphase systems to induce mixing for dissolution and/or reaction processes. The apparatus and methods of the present invention allow micromixing of two or more fluids and can advantageously be used to conduct liquid-phase reactions uniformly and at high rates.

The apparatus and methods of the present invention provide the above by utilizing an electrified injector tube to inject and disperse at least one fluid into the flow of another fluid. Turbulence caused by electrohydrodynamic flows near the tip of the injector tube causes rapid and thorough mixing of the fluids. The rapid micromixing provides a method for conducting liquid-phase reactions uniformly at high rates.

In one embodiment, the apparatus of the present invention comprises a first conduit having an interior space for conveying at least one first liquid and a second conduit having an interior space for conveying at least one second liquid. The second conduit comprises at least two ends and penetrates the first conduit at an opening in the first conduit. The first end of the second conduit receives the at least one second fluid and is located exterior the interior space of the first conduit. The second end of said second conduit terminates in an outlet that is located within the interior space of the first conduit so that the at least one second fluid can be injected into the interior space of the first conduit. The second conduit is electrically insulated from the first conduit at the opening in the first conduit through which the second conduit penetrates the first conduit. At least one electrode is located exterior the interior space of said first conduit and proximate the outlet of the second conduit so that an electric potential difference applied between the outlet of the second conduit and the at least one electrode has an influence on the at least one second fluid exiting the outlet of said second conduit. The apparatus also comprises a means for applying an electric potential between the outlet of the said second conduit and the electrode.

The present invention has widespread value in the chemical industries for mixing and reacting liquid components. For example, large-volume processes that may benefit from the present invention include production of paints and resin suspensions, polymerization reactions, mixing in petroleum production and petrochemical processes, and similar applications. Other fields in which present invention may provide benefits include those requiring very fast reactions or critical applications, such as pharmaceuticals production and semiconductor manufacturing, for which homogeneous reaction media are vital to product purity.

The method of the present invention comprises conveying at least one first fluid in the annular space between the capillary tube and the outer tube, injecting at least one second fluid through a capillary tube and applying an electric field between the capillary tube and outer tube. An electric field is applied between the capillary tube and an electrode placed either on the interior or the exterior of the outer tube. Alternatively, the electric field may be applied between the capillary tube and an electrode comprising the outer tube. The electric field provides electrohydrodynamic flows that induce turbulent mixing of the first and second fluids at the tip of the capillary tube. Either the first fluid or second fluid may contain a species reactive with that of the other fluid to induce particle-producing reactions.

### BRIEF DESCRIPTION OF THE FIGURES

FIG. 1 is an axial cross section through an exemplary apparatus of the present invention.

FIG. 1a is a radial cross section through the exemplary apparatus illustrated in FIG. 1.

FIG. 2 is a series of photo images demonstrating electrohydrodynamic mixing produced by an apparatus and a method of the present invention.

FIG. 3 is a graph illustrating the improved mixing of butanol in water with increasing voltage applied to an apparatus of the present invention.

FIG. 4 is a graph illustrating the variance for mixing ethanol in ethanol at different applied voltages.

FIGS. 5 and 6 are photo images comparing particles produced by an apparatus and a method of the present invention.

FIG. 7 is an axial cross section through an alternative apparatus of the present invention.

FIG. 7a is a radial cross section through the exemplary apparatus illustrated in FIG. 7.

### DETAILED DESCRIPTION OF THE INVENTION

This invention encompasses both methods and apparatus for dispersing one fluid into another fluid by electrical dispersion. The two liquids may be miscible, partially miscible and immiscible and are subject to electrohydrodynamic forces in order to induce mixing. Turbulence caused by electrohydrodynamic flows near the tip of an injector tube causes rapid and thorough mixing of the fluids. The rapid micromixing provides a method for conducting liquid-phase reactions uniformly at high rates. Micromixing is useful and advantageous for dissolution and/or reaction processes and can be used to conduct liquid-phase reactions uniformly and at high rates. A few desirable embodiments and some alternative embodiments of the methods and apparatus of the present invention are described and illustrated as follows.

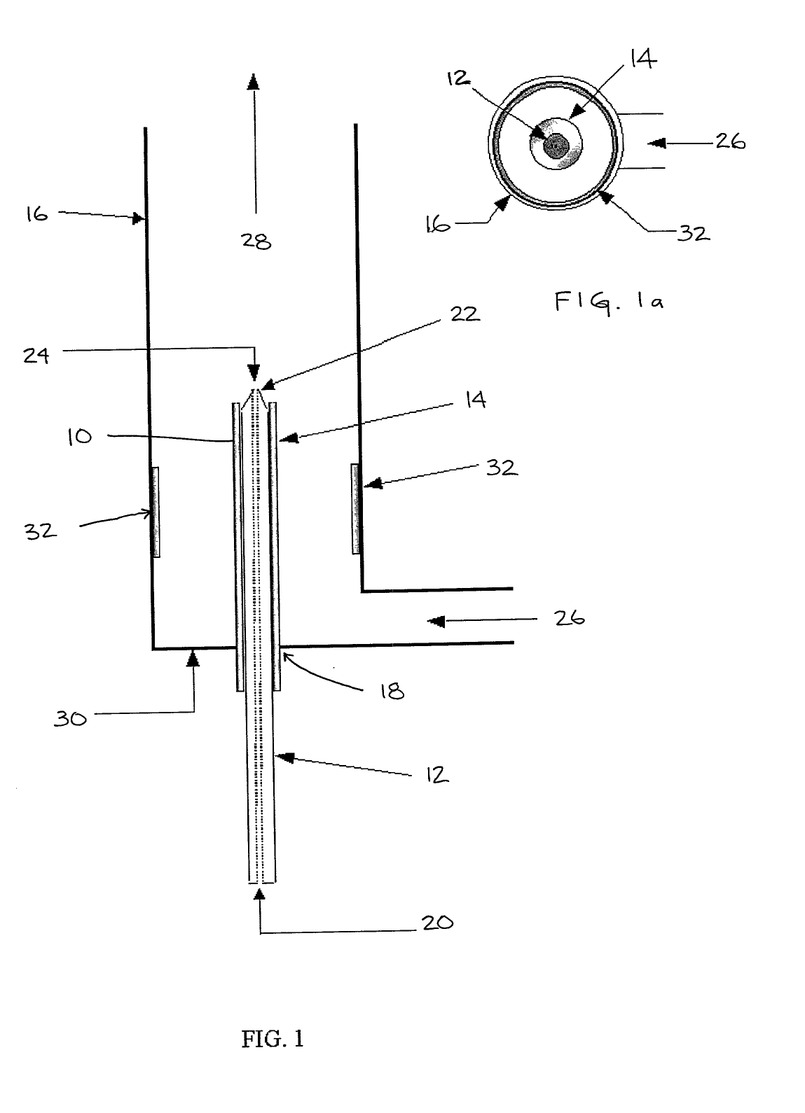

A schematic of one desirable embodiment of an apparatus of the present invention is illustrated in FIGS. 1 and 1a. In the embodiment of the apparatus illustrated in FIGS. 1 and 1a, an injector tube 10, comprising a capillary tube 12 and an insulating tube 14, is disposed partially within and coaxial with a section of a larger, outer tube 16. In the method of the illustrated embodiment, a first fluid is conveyed in the larger outer tube 16 and a second fluid is introduced through the injector tube 10 into the interior of the outer tube and into the first fluid by electrohydrodynamic mixing. The first fluid and second fluid may be completely miscible, partially miscible, or immiscible with each other. Additionally, both the first fluid and second fluid may comprise more than one fluid, specifically more than one chemical species that can be completely miscible, partially miscible, or immiscible. Because the outer tube 16 has a larger diameter than the capillary tube 12 and is capable of handling larger volumes of liquid than the capillary tube 12, the first fluid, the fluid that is conveyed in the annular space between the injector tube 10 and the larger outer tube 16 forms the continuous phase of the resultant solution. The second fluid, which is conveyed within and injected via the capillary tube 12, is introduced into the first fluid and dispersed in the first fluid by electrohydrodynamic mixing.

In the illustrated embodiment, the injector tube 10 comprises a capillary tube 12 that is insulated with an insulating tube 14. The capillary tube 12 has two ends, a first end and a second end. The injector tube 10, or alternatively, the combination of the capillary tube 12 and insulating tube 14, penetrates the outer tube 16 through an opening 18 in the outer tube 16, such that the first end of the capillary tube is located outside of the larger, cylindrical outer tube 16 and the second end of the capillary tube is located within the outer tube 16. Desirably, the seal between the outer tube 16 and the injector tube 10, which in the illustrated embodiment comprises the capillary tube 12 and the insulating tube 14, is fluid tight or substantially fluid tight. At the first end of the capillary tube is located a capillary tube inlet 20 for receiving a fluid. The fluid is conveyed from the capillary tube inlet 20 through the interior of the capillary tube 12 to the second end of the capillary tube at which is located a conical tip 22 that terminates with a capillary tube outlet 24. A fluid that is injected into the capillary tube inlet 20 exits the capillary tube outlet 24 and disperses into any fluid or combination of fluids that is conveyed within the interior of the larger, outer tube 16. The flow of the fluid conveyed within the larger, outer tube 16 can be in the same general direction as the flow of the liquid within the capillary tube 12 or counter to the flow of the liquid within the capillary tube.

The insulating tube 14 electrically insulates the capillary tube 12 from the outer tube 16 and prevents electrical discharge. The insulating tube 14 surrounds and insulates the portion of the capillary tube 12 proximate the opening 18 of the outer tube through which the injector tube 10 is inserted. Desirably, the insulating tube 14 surrounds and insulates the capillary tube 12 from a portion of the capillary tube exterior the outer tube to an area proximate the conical tip 22. The insulating tube 14 can be constructed of any nonconductive material capable of electrically insulating the capillary tube 12 from the outer tube 16. Desirably, the nonconductive material is an electrically insulating material that is compatible with and does not react with any fluid and chemical species to which it may be exposed during normal use. More desirably, the insulating tube is made of a material that is capable of withstanding voltages that may be applied to the capillary tube and apparatus. Suitable insulating materials include, but are not limited to, ceramics, various glass compositions, and chemically and electrically resistant plastics such as TEFLON. Alternatively, the injector tube can be a capillary tube that is coated with an insulating material rather than comprising a capillary tube and a separate insulating tube. In the apparatus of the Examples, insulating tube 14 extended from outside of the opening 18 in the outer tube 16 to an area even with the opening 24 in the conical tip 22

The capillary tube 12 can be constructed of any electrically conductive material or a combination of materials comprising a layer of a conductive material or a conductive tip 22. Desirably, the insulator tube, the capillary tube and tip are constructed of materials that are compatible with and that are not chemically reactive with any fluids and any chemically reactive species that they may be exposed to. More desirably, the material is able to withstand electrical breakdown. In the embodiment of the apparatus used in the Examples, the capillary tube is made of a metal alloy, specifically, a stainless steel. Stainless steel was chosen because of its commercial availability, high conductivity and relative inertness. In instances where stainless steel and other metals may not be desirable, because such metals may react with the fluids and species contained and generated within the apparatus, the exposed parts of the capillary tube, particularly the conical tip, and even the entire capillary can be made of graphite or a conductive polymer. Desirably, the tip is conical and the material from which the tip is made is not reactive with or detrimental to the fluids and species contained and generated within the apparatus and resists electrical breakdown.

The outer tube 16 is larger than the injector tube 10 or the capillary tube 12 and the insulating tube 14 that surrounds the capillary tube 12 and is designed such that it conveys at least one fluid. The outer tube 16 comprises an inlet 26 for receiving at least one fluid and an outlet 28 for providing fluid. The outer tube can be a straight tube or pipe or can be curved and comprise one or more turns 30 or bends. The outer tube 16 can be made of any material that is capable of conveying fluids. The material(s) from which the outer tube is constructed can be conductive or nonconductive. Examples of conductive materials from which the outer tube can be made include, but are not limited to, various metals and their alloys, such as, ductile iron, cast iron, stainless steel, brass, copper, etc. Suitable nonconductive materials from which the outer tube can be made include, but are not limited to, glass, ceramics and TEFLON. When the outer tube 16 is constructed from a nonconductive material and the outer tube 16 is itself substantially nonconductive, at least one electrode 32 is positioned in proximity of the capillary tube outlet 24.

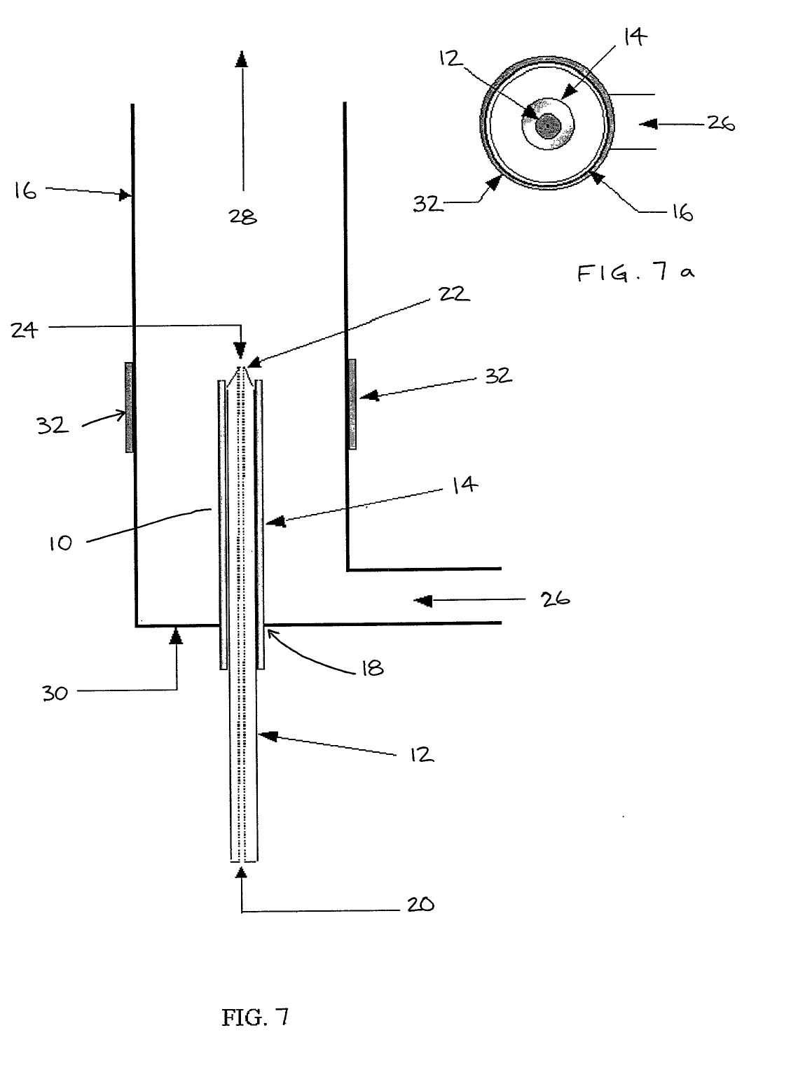

The electrode 32 or more than one electrode can be positioned along the inside or outside of the outer tube wall and may even be integral and formed as a component for the outer tube wall. By way of nonlimiting examples, the electrode can be one or more conductive elements such as a metal strip, rod or disk that can be placed along the wall of the outer tube 16 and parallel with the axis of outer tube or the electrode can be a metal strip or rod that is wrapped around the circumference of the outer tube proximate the capillary tube outlet, either inside, outside or forming an integral portion of the outer tube wall. In the apparatus used in following Examples, a portion of the outer tube below capillary tube outlet 24 was constructed of metal. The remaining portion of the outer tube was constructed of glass. The metal portion of the outer tube functioned as the electrode 32. In this embodiment, at least a portion of the outer tube 16 can be formed from a metal or other conductive material in proximity to the capillary tube outlet 24 such that an electric potential difference between the portion of the outer tube that is conductive and the capillary tube outlet 24, the conical tip 22, the capillary tube 12 or the injector tube 10 has an influence on the fluid exiting the outlet and induces electrohydrodynamic mixing of the fluid. In another alternative embodiment illustrated in FIGS. 7 and 7a, the electrode 32 is separate from and exterior the outer tube 16. FIG. 7a is an exaggerated radial cross section through the exemplary apparatus illustrating the relative positions, from inside to outside, of the capillary tube 12, the insulating tube 14, the outer tube 16, and the electrode 32.

A means for applying an electric potential at the outlet 24 can be any means of power supply capable of generating a potential difference between the outlet 24 and an electrode or a conductive portion of the outer tube proximate the outlet 24. In the illustrated embodiment, the metal capillary tube 12 is connected to a high-voltage power supply. The outer tube wall can be conductive or comprise a conductive portion proximate outlet 24 and is connected to the other lead of the power supply or electrical ground. Desirably, all wetted surfaces inside the apparatus should be constructed of materials that are nonreactive with the process fluids and the conical tip 22, capillary tube or injector tube outlet 24 are constructed of material capable of withstanding voltages that may be applied.

At least two fluids are introduced into the device. A first fluid that may comprise one or more fluids or chemical species is conveyed in the outer tube 16. A second fluid that also may comprise one or more fluids or chemical species is conveyed in the inside of the metal capillary or injector tube. In the illustrated embodiment, the first fluid is conveyed in the annular space between nonconductive tube that insulates the capillary and the outer tube and forms the continuous phase of a solution of the first and second fluids. The second fluid, which may be miscible, partially miscible or immiscible with the first fluid forms the dispersed phase in the solution. The flow rate of both fluids may be adjusted individually to affect the output flow. For example, the ratio of the flow of either fluid may be adjusted relative to the other fluid to affect the reaction dynamics. Application of a high-voltage potential difference between the metal capillary and the outer electrode or conductive portion results in enhanced mixing of the two fluids. This mixing is due to electrohydrodynamic flows caused by the motion of charge carriers in the electric field.

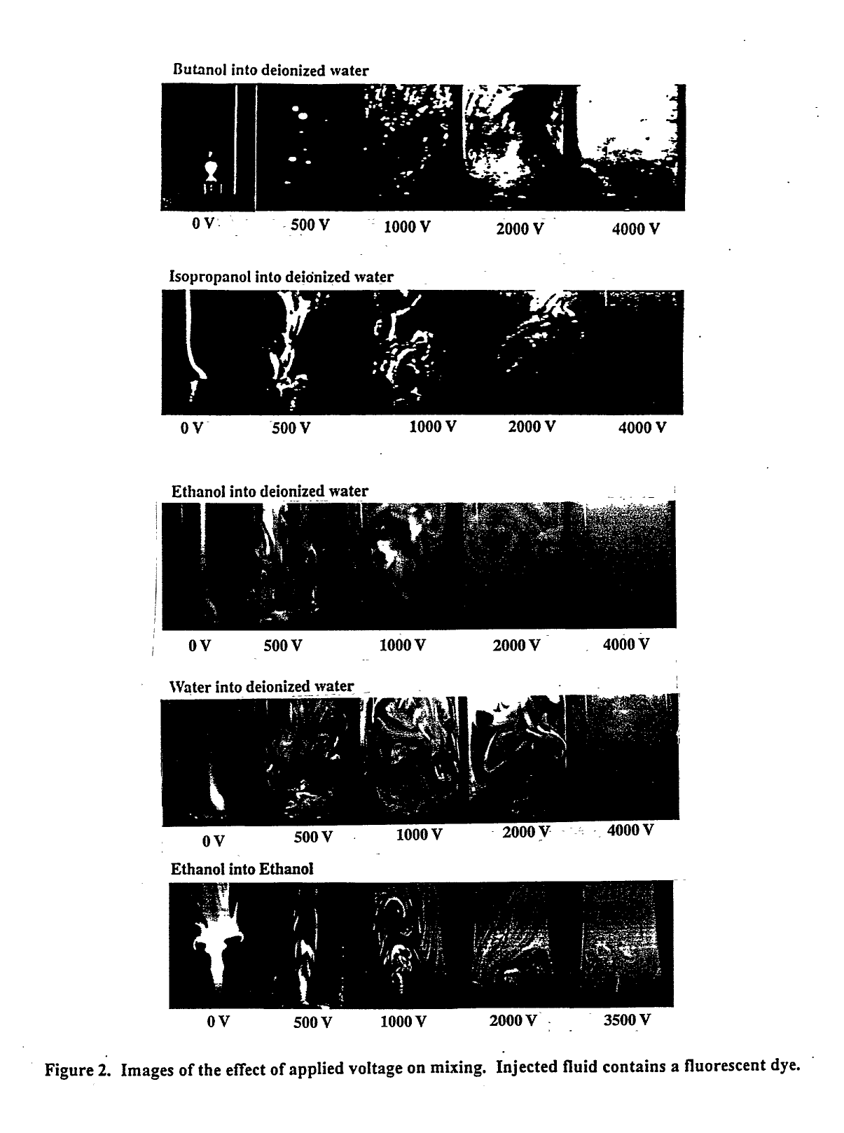

FIG. 1a is an exaggerated radial cross section through the exemplary apparatus illustrating the relative positions, from inside to outside, of the capillary tube outlet 24, the conical tip 22, the capillary tube 12, the insulating tube 14, the electrode 32, and the outer tube 16. The diameter of the capillary tube outlet 24 can vary and is not necessarily related to either the inside or outside diameter of the outer tube 16 and will depend on the desired flow rate and the physical properties of the fluids, such as viscosity, electrical conductivity, etc. Suggested outlet diameters range from about one-tenth of a millimeter to about 1 millimeter. The outside diameter of the capillary tube or injector tube can vary, suggested diameters include from about one-half a millimeter to about 5 millimeters. Suggested outer tube diameters range from about 5 millimeters to about 100 millimeters. It should be noted that the diameters of both can vary to increase or to decrease flow and to promote greater mixing. In the apparatus that was used in Examples 1-8 below, the diameter of the outlet and the inside diameter of the capillary tube were 0.030 inches (0.76 millimeters), the outside diameter of the capillary tube was 1.6 mm, the outside diameter of the insulation tube was 3.2 mm, and the inside diameter of the outer tube was 7.5 mm. In the apparatus that was used in Example 9, the diameter of the outlet and the inside diameter of the capillary tube were 0.030 inches (0.76 millimeters), the outside diameter of the capillary tube was 1.6 mm, the outside diameter of the insulation tube was 3.2 mm, and the inside diameter of the outer tube was 9.5 mm. The dispersions produced by this apparatus are illustrated in FIGS. 2-5. In the apparatus that was used to generate Examples, the diameter of the tip and the inside diameter of the capillary tube were the same.

The key to efficiently establishing turbulent electrohydrodynamic flows for fluid mixing is to provide a good source of ions for charge injection at the point that the injected fluid enters the continuous fluid, yet minimizing current flow. This is achieved through the design of the injector tube. The conical tip provides a region of high field gradient in which charge can concentrate and be injected into the fluid. In the illustrated embodiment, insulation is provided over all of the outer surface of the capillary tube within the outer tube except for the vicinity of the conical tip. The insulation provides a means to minimize current. Generally, a toroidal electrohydrodynamic flow field is generated that is outward from the conical tip along the axis of the tube, and circulating back along the outer tube wall. This flow interacts with the pressure-driven flow field that is directed primarily parallel to the axis of the tube. Depending on the properties of the fluids and the applied field strength, a variety of flow fields can be generated. Generally, a higher applied voltage results in increased electrohydrodynamic flow velocities and increased turbulence for more rapid mixing. The methods and apparatus of the invention may be applied to a wide variety of fluids; in principle, nearly any fluid may be used as the injected fluid, while the continuous fluid should be limited to liquids of low enough conductivity that significant Ohmic conduction does not occur. Suggested fluids of low conductivity include, but are not limited to, deionized water. Deionized water is an effective continuous fluid, while electrolyte solutions are typically not desired due to electrolysis, high current, and poor generation of electrohydrodynamic flow. Better performance is expected for continuous fluids having high dielectric constant and relatively low conductivity, including, but not limited to, alcohols and deionized water which have proven to be very suitable. The performance of an apparatus and a method of the present invention are illustrated by example results as described below.

Laboratory testing of a device constructed as shown in FIG. 1 has demonstrated that electrohydrodynamic flows can be employed to rapidly and efficiently mix miscible and partially miscible fluids. An exemplary apparatus was constructed with a 0.76 mm inner diameter and 1.6 mm outer diameter metal capillary having a conical tip. The length of conical section of the capillary was about 2.5 mm. The capillary was enclosed in a glass insulating tube of 1.6 mm inner diameter and 3.2 mm outer diameter extending from an area proximate the conical section to outside the outer tube. The capillary tube and insulating tube were disposed along the axis of an outer tube having a 7.5 mm inner diameter. The outer tube was constructed mainly of glass, with a glass-to-metal transition placed about 3 mm upstream from the exit of the capillary. The metal capillary and metal portion of the outer tube were connected to opposite leads of a high-voltage D.C. power supply as illustrated in FIG. 1. These connections were used to provide an electrical potential difference and induce electrohydrodynamic mixing.

FIG. 2 shows representative results obtained for five example systems: (1) butanol injected into deionized water, (2) isopropyl alcohol injected into deionized water, (3) ethanol injected into deionized water, (4) water injected into deionized water, and (5) ethanol injected into ethanol. In each case, the liquid was injected at a flow rate of 0.8 ml//min into a stream flowing at 50 ml/min. The injected liquids contained a dissolved fluorescent dye so that mixing could be observed. The images in FIG. 2 were obtained by illumination with a laser-light sheet aligned with the axis of the tube and perpendicular to the direction of visualization. When no voltage was applied, dispersion and dissolution were observed to be relatively slow. Increasing voltage resulted in much more rapid and intense micromixing. This micromixing is very advantageous for reactive systems. Because the mixture is homogenized very quickly, it is possible to continuously operate mixing systems with faster reaction rates and yet result in a homogeneous product.

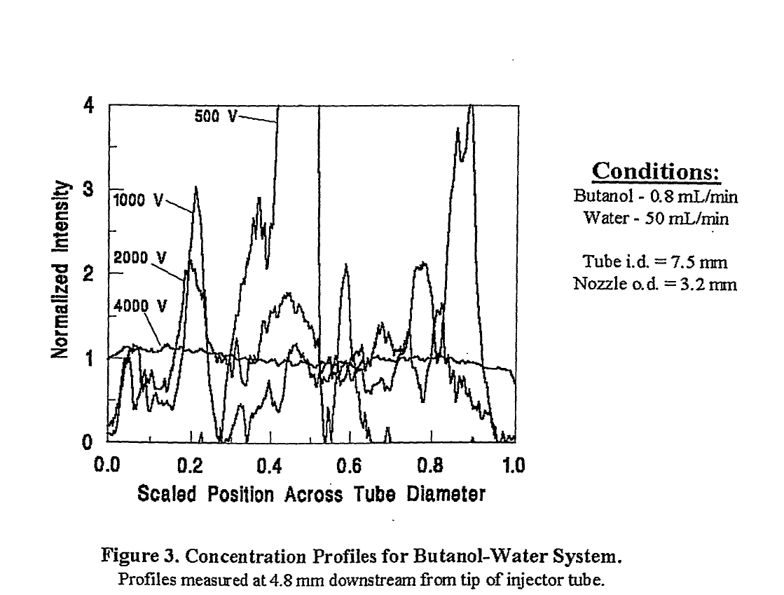

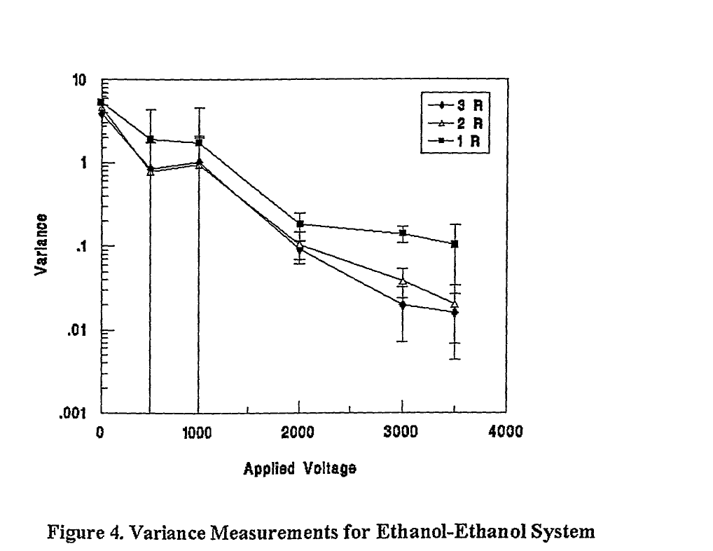

Measures of the effectiveness of this approach for rapid mixing were obtained from image analysis of the dye fluorescence signal. The intensity of fluorescent signal is directly related to dye concentration. Examples of intensity profiles under different conditions are shown in FIG. 3 for a butanol-water system. At lower voltages, the intensity varies greatly throughout the tube cross-section. When voltage is applied the intensity is more equal and at higher voltages the intensity signal is essentially constant. A useful measure of the effectiveness of mixing is the variance of the signal intensity. A lower variance means lower variability in concentration, and thus better mixing. The variance was calculated from measurements of intensity profiles at three distances from the tip, at 1, 2, and 3 outer radii of the insulator tube, for 5 frames at each set of experimental conditions. The results of these measurements for the ethanol-ethanol system are shown in FIG. 4. A decrease in the variance of over two orders of magnitude was achieved by the application of 4000 volts. The liquids were essentially completely mixed within 3 radii of the injector, or within approximately 250 milliseconds at the overall combined flow rate.

The apparatus of the present invention is capable of various modifications from those described and illustrated without departing from the spirit and scope of the invention. A few of which are discussed below. Generally, the outer tube 16, injector tube 10 and the capillary tube 12 are conduits and can be of any shape capable of conveying fluids. The term “conduit” as used herein indicates a channel through which something, especially fluids, can be conveyed. The term “fluid” as used herein includes liquids and gasses. Examples of conduits include, but are not limited to, pipes, tubes, capillaries, and the like. The term “capillary” as used herein indicates a conduit having a very small opening. Desirably, the capillary tube 12 should have an opening with a cross sectional area that is at least two orders of magnitude smaller than the cross sectional area of the outer tube 16 where the opening of the capillary tube outlet 24 is located. The cross sections of the outer tube 16 and injector tube 10 are typically both circular but can vary in size and shape and can also vary in shape from each other. For example, the cross section of either or both the outer tube and the injector tube can be elliptical and can be increased or decreased to increase or decrease the flow and/or pressure.

In a preferred embodiment, the center of the opening of the capillary is aligned with the central axis of the conduit through which the dispersed phase is conveyed. This may be achieved by disposing the capillary coaxially within the section of the conduit through which the capillary is disposed as illustrated in FIGS. 1 and 1a. Alternatively, the capillary can be tangentially disposed within the conduit, preferably so that the open end of the capillary coincides with the central axis of the conduit or the capillary can be obliquely disposed within the conduit. The conduit and the capillary do not necessarily have to have substantially linear axes as in the illustrated embodiments and can be curved or contain curves, bends and the like.

The apparatus of the present invention can comprise more than one capillary. For example, the apparatus of the present invention can comprise a second capillary disposed adjacent the first capillary so that a second disperse phase can be introduced to the continuous phase at the same time and location as the first dispersed phase. An additional, second and even third capillary can be disposed within the conduit adjacent the first capillary or in a different location in the conduit from the first and other optional capillaries. Multiple capillaries can be used to inject more than one dispersed phase or to disperse more of a single dispersed phase.

The method of the present invention provides a process for rapid dispersion, dissolution, and/or liquid-phase reactions. The process is accomplished through the use of electrohydrodynamic flows in the vicinity of an electrified capillary tube placed inside another tube to induce efficient turbulent mixing of two fluids, which may contain reactive species. The process may be accomplished through the use of one or more capillary tubes. Rapid micromixing allows liquid-phase reactions to be conducted at high rates.

A first fluid may be introduced continuously into the reactor and may be miscible, partially miscible, or immiscible with the second fluid. Almost any fluid may be used as the second fluid. However, it is preferred that the first fluid have a sufficiently low electrical conductivity that significant Ohmic conduction does not occur. In addition, it is preferred that the first fluid have a high dielectric constant. Examples of fluids having these characteristics include deionized water, ethanol, other alcohols, and their mixtures, etc.

In one method of the present invention, two fluids are introduced into the reactor. The first fluid comprises a reactive species and is introduced through the capillary tube inlet 20 and injected through the capillary tube 12, and a second fluid is introduced through the inlet 26 of the outer tube 16 in the annular space between the capillary tube 12 and the outer tube 16. The second fluid contains a species reactive with that of the first fluid. Electrohydrodynamic flows caused by charge injection at the tip 22 of the capillary tube 12 induce turbulent mixing in the vicinity of the tip 22. This leads to rapid and complete mixing of the reactants. The mixed fluids pass down the outer tube 16, during which time the reactions proceed.

One method of the present invention is described in the U.S. Patent Application “Method for the Production of Ultrafine Particles by Electrohydrodynamic Micromixing”, David W. DePaoli, Constantinos Tsouris, and Zhong-Cheng Hu, filed concurrently herewith and which is incorporated herein by reference in its entirety. In one of the methods described in the above referenced U.S. Patent Application, fluids containing species that undergo particle-producing reactions are introduced into the reactor. Suitable reaction systems for the present invention include sol-gel reactions. For example, sol-gel reactions can be conducted employing a first fluid comprised of organometallic species such as alkoxides dissolved in an alcohol. Suitable alkoxides include, but are not limited to, zirconium butoxide, zirconium ethoxide, or zirconium isopropoxide. Examples of alcohols include, but are not limited to, ethanol, butanol, methanol, and isopropanol. The reactant in the second fluid is typically water, which induces hydrolysis and condensation of the alkoxides in the first fluid. This approach allows continuous or batch production of non-agglomerated, monodispersed, submicron-sized, sphere-like powders. The size and homogeneity of the product can be controlled through selection of reaction conditions, including reactant concentrations, type of solvent, fluid flow rates, and applied voltage.

In another embodiment of the present invention, multiple capillary tubes are used within a single outer tube to achieve electrohydrodynamic mixing in larger quantities or for the introduction of multiple fluid streams.

This invention is further illustrated by the following examples, which are not to be construed in any way as imposing limitations upon the scope thereof. On the contrary, it is to be clearly understood that resort may be had to various other embodiments, modifications, and equivalents thereof, which, after reading the description herein, may suggest themselves to those skilled in the art without departing from the scope or the present invention.

### EXAMPLES

Examples 1-5 illustrate the level of electrohydrodynamic mixing accomplished by the method of the present invention. No reactions took place in these examples. An electrohydrodynamic micromixing reactor was used to mix systems of butanol, isopropanol, ethanol, and water containing a fluorescent dye injected into deionized water or ethanol. The reactor comprised a capillary tube having an inside diameter of 0.76 mm and outside diameter of 1.6 mm. The outer tube had an inside diameter of 7.5 mm, was constructed of stainless steel, and was connected to an electrical ground to create an electric field between the capillary tube and the outer tube. Once the fluids were injected into the reactor, video images were taken of the streams with no voltage applied, and with applied voltages of 500 V, 1000 V, 2000 V and 3500 V or 4000 V. After each increase in voltage the system was allowed to steady out, although this occurred almost instantaneously.

### Example 1

Butanol comprising a small amount of the fluorescent dye uranine was injected into the capillary tube of the electrodynamic micromixing reactor at a rate of 0.8 mL/min. Deionized water was introduced as a continuous fluid in the outer tube at a rate of 50 mL/min.

### Example 2

Isopropanol comprising a small amount of the fluorescent dye uranine was injected into the capillary tube at a rate of 0.8 mL/min. Deionized water was introduced as a continuous fluid in the outer tube at a rate of 50 mL/min.

### Example 3

Ethanol comprising a small amount of uranine was injected into the capillary tube of the electrodynamic micromixing reactor at a rate of 0.8 mL/min. Deionized water was introduced as a continuous fluid in the outer tube at a rate of 50 mL/min.

### Example 4

Water comprising a small amount of the fluorescent dye sodium fluorescein was injected into the capillary tube of the electrodynamic micromixing reactor at a rate of 0.8 mL/min. Deionized water was introduced as a continuous fluid in the outer tube at a rate of 50 mL/min.

### Example 5

Ethanol comprising the fluorescent dye uranine was injected into the capillary tube of the electrodynamic micromixing reactor at a rate of0.8 mL/min. Ethanol was also introduced as a continuous fluid in the outer tube of the reactor at a rate of 50 mL/min.

The electrohydrodynamic mixing accomplished in Examples 1-5 is illustrated visually in FIG. 2. As can be seen, with no voltage applied between the electrodes, dispersion and dissolution are relatively slow, while with increasing voltage, much more rapid and intense micromixing is achieved.

In Examples 6 and 7, experiments were conducted using a sol-gel reaction system in which the two key reactants were a metallorganic precursor, zirconium tetra-n-butoxide (ZTB) and water. These experiments demonstrate that an electrohydrodynamic micromixing reactor can be used to overcome the challenges posed by rapid reaction kinetics in a metal alkoxide system. A solution of zirconium tetrabutoxide in alcohol was dispersed under different conditions of applied voltage into a flowing stream of the same alcohol having a given concentration of deionized water.

### Example 6

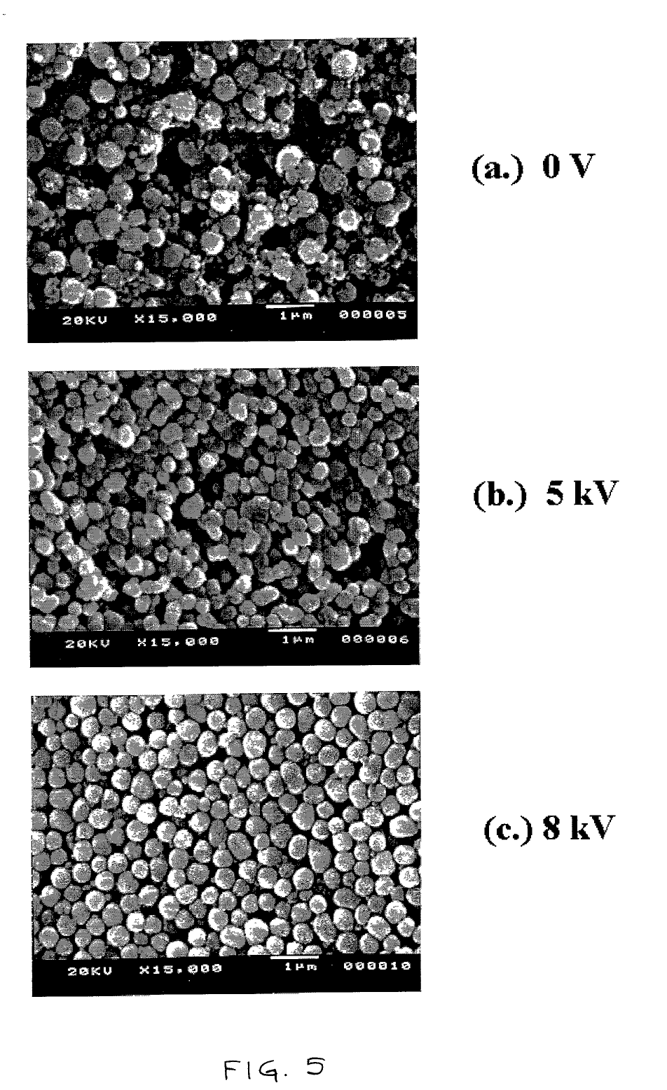

Experiments were conducted to demonstrate the effect of applied voltage on product quality for a butanol-butanol system. The electrohydrodynamic micromixing reactor used in this example comprised a capillary tube having an inside diameter of 0.50 mm and outside diameter of 1.6 mm. The outer tube had an inside diameter of 9.5 mm. The insulation tube had an outside diameter of 3.2 mm and was flush with the end of the conical tip of the capillary tube. The outer tube was constructed of stainless steel and was connected to an electrical ground to create an electric field between the capillary tube and the outer tube. A 1.923 M ZTB in butanol solution was injected at a flow rate of 1.3 mL/min. into a 0.527 M butanol in water solution having a flow rate of 23.7 mL/min. The combination of these two streams resulted in a reaction mixture of 0.5 M water and 0.1 M ZTB. Video images were taken of the streams with no voltage applied and with applied voltages of 5000 V and 8000 V. The results are set forth in FIG. 5.

Under conditions with no applied voltage, macroscopic hydrodynamic mixing and diffusion controlled the contact of the reactants in the medium, and as shown in FIG. 5(a) a heterogeneous product was formed. In addition, at lower voltages, corresponding to lesser uniformity of the reactant mixture, there is greater particle agglomeration as demonstrated in FIG. 5(b). Homogeneity of the product was improved by the application of 5000 V. However, with an applied voltage of 8000 V, a highly desirable product was formed that is relatively dense, non-agglomerated, nearly spherical, and has a narrow size distribution. (See FIG. 5(c)).

### Example 7

A pair of experiments was conducted to: (1) demonstrate the effectiveness of the present invention for producing homogeneous particles compared to conventional methods, and (2) to display how electrohydrodynamic micromixing can be used to controllably produce particles of ultrafine size by injecting a highly concentrated reactant stream.

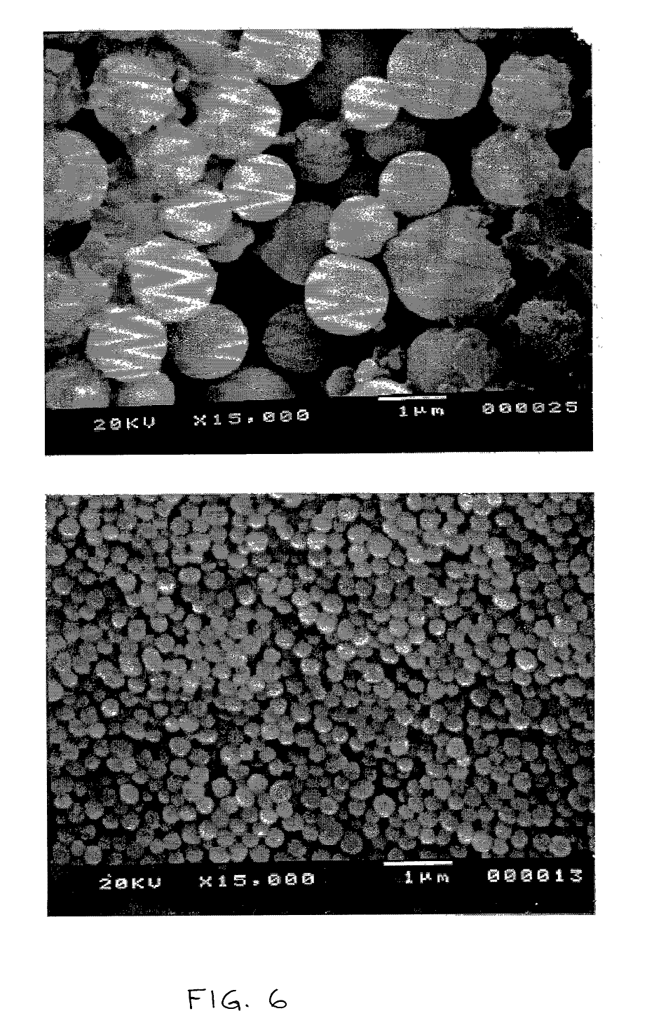

Each experiment had an overall concentration of reactants in the mixed solution before reaction of 0.1 M ZTB and 0.3 M water in butanol. In the first experiment, for which the resulting product is shown in FIG. 6(a), equal volumes of two solutions (one 0.2 M ZTB in butanol and the other 0.6 M deionized water in butanol) were mixed by a conventional approach of rapidly introducing them into a stirred beaker. The second experiment was conducted using an electrohydrodynamic micromixing reactor having the same configuration as in Example 6. In this experiment, a solution of 1.923 M ZTB in butanol was injected at a flow rate of 1.3 mL/min into a solution of 0.316 M deionized water in butanol flowing at 23.7 mL/min, with an applied voltage of 8 kV. The product of the second experiment is shown in FIG. 6(b).

Although the total amounts of reactants were the same in both experiments, the products were significantly different. This is due to two factors. First, the improved mixing achieved by the electrohydrodynamic flows leads to better homogeneity than the conventional mixing cases. Second, the rapid homogenization achievable through electrohydrodynamic mixing allows the injection of a much more concentrated reactant stream. This increases the nucleation rates during initial reaction stages, resulting in a larger number of smaller particles.

It should be understood that the foregoing relates to particular embodiments of the present invention, and that numerous changes may be made therein without departing from the scope of the invention as defined by the following claims.

We claim:

1. An apparatus for mixing fluids comprising:
a first conduit having an interior space for conveying at least one first liquid;
a second conduit having an interior space for conveying at least one second liquid, the second conduit comprising at least two ends and penetrating the first conduit at an opening in the first conduit, the first end of said second conduit for receiving the at least one second fluid is located exterior the interior space of the first conduit and the second end of said second conduit terminates in an outlet that is located within the interior space of the first conduit so that said at least one second fluid can be injected into the interior space of the first conduit and the second conduit electrically insulated from the first conduit at the opening in the first conduit through which the second conduit penetrates the first conduit;
at least one electrode located exterior the interior space of said first conduit and proximate the outlet of said second conduit so that an electric potential difference applied between the outlet of said second conduit and the at least one electrode has an influence on the at least one second fluid exiting the outlet of said second conduit; and
a means for applying an electric potential difference between the outlet of the said second conduit and the electrode.

2. The apparatus of claim 1, wherein said at least one first liquid flows in said first conduit in a direction different from the direction of the flow of said at least one second fluid that is conveyed in and flows through said second conduit.

3. The apparatus of claim 1, wherein the at least one electrode is integral with or forms a portion of said first conduit.

4. The apparatus of claim 1, wherein the at least one electrode is exterior said first conduit.

5. The apparatus of claim 1, wherein the diameter of the outlet of the second conduit ranges from about 100 microns to about 2 millimeters.

6. The apparatus of claim 1, wherein the inner diameter of the first conduit ranges from about 0.1 centimeters to about 10 centimeters.

7. The apparatus of claim 1, wherein said second conduit is electrically insulated from the first conduit by a coating of a nonconductive material on the exterior surface of said second conduit

8. The apparatus of claim 1, wherein said second end of said second conduit terminates in a conical tip.

9. The apparatus of claim 1, wherein the apparatus further comprises a third conduit having an interior space for conveying at least one liquid, the third conduit comprising at least two ends and penetrating the first conduit at an opening in the first conduit, the first end of said third conduit for receiving the at least one fluid is located exterior the interior space of the first conduit and the second end of said third conduit terminates in an outlet that is located within the interior space of the first conduit so that said at least one fluid can be injected into the interior space of the first conduit and the third conduit electrically insulated from the first conduit at the opening in the first conduit through which the third conduit penetrates the first conduit

10. An apparatus for mixing fluids comprising:
a conduit having an interior space for conveying at least one first liquid;
a metal capillary having an interior space for conveying at least one second liquid, the metal capillary comprising at least two ends and penetrating the conduit at an opening in the conduit, the first end of said metal capillary for receiving the at least one second fluid is located exterior the interior space of the conduit and the second end of said metal capillary terminates in an outlet that is located within the interior space of the conduit so that said at least one second fluid can be injected into the interior space of the conduit;
an insulating means disposed around the metal capillary from a portion of the metal capillary exterior the conduit and the opening in the conduit through which the metal capillary penetrates the conduit to an area proximate the outlet of the metal capillary;
at least one electrode located exterior the interior space of said conduit and proximate the outlet of said metal capillary so that an electric potential difference applied between the outlet of said metal capillary and the at least one electrode has an influence on the at least one second fluid exiting the outlet of said metal capillary; and
a means for applying an electric potential difference between the outlet of the said metal capillary and the electrode.

11. The apparatus of claim 10, wherein said at least one first liquid flows in said conduit different from the direction of the flow of said at least one second fluid that is conveyed in and flows through said metal capillary.

12. The apparatus of 10, wherein the at least one electrode is integral with or forms a portion of said conduit.

13. The apparatus of claim 10, wherein the at least one electrode is exterior said conduit.

14. The apparatus of claim 10, wherein the diameter of the outlet of the metal capillary ranges from about 100 microns to about 2 millimeters.

15. The apparatus of claim 10, wherein the inner diameter of the conduit ranges from about 0.1 centimeters to about 10 centimeters.

16. The apparatus of claim 10, wherein the insulating means comprises a coating of a nonconductive material on the exterior surface of said metal capillary.

17. The apparatus of claim 10, wherein the insulating means comprises a tube of an insulating material disposed around the metal capillary.

18. The apparatus of claim 10, wherein said metal capillary comprises a conical tip.

19. The apparatus of claim 10, further comprising
a second metal capillary having an interior space for conveying at least one liquid, the metal capillary comprising at least two ends and penetrating the conduit at an opening in the conduit, the first end of said metal capillary for receiving the at least one second fluid is located exterior the interior space of the conduit and the second end of said metal capillary terminates in an outlet that is located within the interior space of the conduit so that said at least one second fluid can be injected into the interior space of the conduit; and
an insulating means disposed around the metal capillary from a portion of the metal capillary exterior the conduit and the opening in the conduit through which the metal capillary penetrates the conduit to an area proximate the outlet of the metal capillary.

20. An apparatus for mixing fluids comprising:
a conduit having an interior space for conveying at least one first liquid and comprising a metal conductive portion;
a metal capillary having an interior space for conveying at least one second liquid, the metal capillary comprising at least two ends and penetrating the conduit at an opening in the conduit, the first end of said metal capillary for receiving the at least one second fluid is located exterior the interior space of the conduit and the second end of said metal capillary terminates in an outlet that is located within the interior space of the conduit and proximate the metal conductive portion of the conduit so that said at least one second fluid can be injected into the interior space of the conduit and is influenced by an electrical potential difference between the metal capillary and the metal portion of the conduit;
an insulating means disposed around the metal capillary from a portion of the metal capillary exterior the conduit and the opening in the conduit through which the metal capillary penetrates the conduit to an area proximate the outlet of the metal capillary; and
a means for applying an electric potential difference between the outlet of the said metal capillary and the metal conductive portion of the conduit.

21. The apparatus of claim 20, wherein said at least one first liquid flows in said conduit in a direction that is different from the direction of the flow of said at least one second fluid that is conveyed in and flows through said metal capillary.

22. The apparatus of claim 20, wherein the diameter of the capillary tube outlet ranges from about 100 microns to about 2 millimeters.

23. The apparatus of claim 20, wherein the inner diameter of the conduit ranges from about 0.1 centimeters to about 10 centimeters.

24. The apparatus of claim 20, wherein the insulating means comprises a coating of a nonconductive material on the exterior surface of said metal capillary.

25. The apparatus of claim 20, wherein the insulating means comprises a tube of a substantially nonconductive material disposed around the metal capillary.

26. A method of mixing fluids comprising:
conveying at least one first fluid through a first conduit having an interior space;
conveying at least one second fluid through a second conduit having an interior space, the second conduit comprising at least two ends and penetrating the first conduit at an opening in the first conduit, the first end of said second conduit for receiving the at least one second fluid is located exterior the interior space of the first conduit and the second end of said second conduit terminates in an outlet that is located within the interior space of the first conduit so that said at least one second fluid is injected into the interior space of the first conduit and the second conduit electrically insulated from the first conduit at the opening in the first conduit through which the second conduit penetrates the first conduit;
applying an electric potential difference between the outlet of said second conduit and at least one electrode located exterior the interior space of said first conduit and proximate the outlet of said second conduit so that an electric potential difference applied between the outlet of said second conduit and the at least one electrode has an influence on the at least one second fluid exiting the outlet of said second conduit and induces micromixing of said at least one first fluid and said at least one second fluid.

27. The method of claim 26, wherein said at least one first fluid is conveyed in and flows in said first conduit in a direction different from the direction of the flow of said at least one second fluid that is conveyed in and flows through said second conduit.

28. The method of claim 26, wherein said at least one first fluid is conveyed in and flows in said first conduit in a direction that is substantially the same as the direction of the flow of said at least one second fluid that is conveyed in and flows through said second conduit.

29. The method of claim 26, wherein said at least one first fluid is miscible with said at least one second fluid.

30. The method of claim 26, wherein said at least one first fluid is at least partially miscible with said at least one second fluid.

31. The method of claim 26, wherein said at least one first fluid comprises at least one reactive species that is reactive with at least one species that is contained in said at least one second fluid.

32. The method of claim 26, wherein said at least one first fluid is at least partially miscible with said at least one second fluid.

33. The method of claim 26, wherein the electric potential difference is applied between the outlet of said second conduit and at least one electrode is a high voltage direct current, a pulsed direct current or an alternating current.

34. The method of claim 26, wherein the first fluid has a high dielectric constant and low conductivity.

35. The method of claim 26, wherein electrodynamic flows of said at least one first fluid and said at least one second fluid are caused by charge injection at the tip of the second conduit.

36. The method of claim 35, wherein the electrodynamic flows induce turbulent mixing of said at least one first fluid and said at least one second fluid.
